(19) United States
(12) Patent Application Publication
(10) Pub. No.: US 2017/0064908 A1
(43) Pub. Date: Mar. 9, 2017

(54) BALE AND MODULE WRAP CUTTING SYSTEM AND METHOD

(71) Applicant: Luke B. Sell, Rosebud, TX (US)

(72) Inventor: Luke B. Sell, Rosebud, TX (US)

(21) Appl. No.: 14/846,582

(22) Filed: Sep. 4, 2015

(51) Int. Cl. A01F 29/00; B26D 7/06; B26D 1/03; B65B 69/00; B26D 3/08

(52) U.S. Cl. CPC A01F 29/005; B65B 69/0025; B26D 3/08; B26D 1/03; B26D 7/06

(57) ABSTRACT

A bale and module wrap cutting system and method can include a bed with rollers that move a wrapped bale from an entrance, passing two cutting devices, such as circular saws, and then passing the bale over a husking devices that utilizes two or more rotating conveyors having protruding cleats that peel a cut section of the wrap enclosing the bale and discard the cut section below the bed. The bale and module wrap cutting system can be mounted on a trailer to be easily transported. The bale may contain agricultural products such as cotton, hay, or grass.

### TECHNICAL FIELD

This disclosure relates to a bale cutting system configured to cut a wrap enclosing a bale or module containing products like cotton, hay, recycled goods, or the like. The bale cutting system can be employed wherever a conventional bale cutting system is used with additional benefits as described herein

### BACKGROUND

Many loose or bulk products are housed in bales or modules wrapped in a wrapper such as plastic. Large round bales of hay or round modules of cotton are commonly used in agriculture. Because many of these bales and modules may be very large and heavy, heavy equipment may be required to manipulate the bales and modules. For example, a round cotton module (which looks very similar to a round hay bale) may weigh 2,500 to 3,500 kg and have a diameter of around 2 m and a length of about 2.7 m. Current machinery cutting the wrap from cotton modules requires numerous employees to manually cut the wrap and/or expensive equipment to lift the heavy cotton modules.

### SUMMARY

A need exists for an improved bale cutting system and method for providing the same. Accordingly, in one aspect, a bale cutting system is provided herein. The bale cutting system may comprise a bed configured to move a bale having a length L and a width W from an entrance portion of the bed towards an exit portion of the bed; a first cutting device movably coupled to a first side portion of the bed through a first arm; a second cutting device movably coupled to a second side portion of the bed through a second arm, the second cutting device being positioned approximately opposite the first cutting device; and a plurality of cleats positioned between the first and second cutting devices and the exit portion, wherein the plurality of cleats are coupled to a plurality of conveyors configured to rotate against the movement of the bale.

In some aspects, the first and second cutting devices are configured to cut a drop section of a wrap enclosing at least some of the bale by cutting the wrap at a cutting height. In some aspects, at least one of the first and second cutting devices comprise a powered circulating saw. In another aspect, the powered circulating saw comprises a circulating saw blade having a blade diameter of 10 to 25 cm.

The bale cutting system can further comprise a first lateral offset comprising the distance between the first and second cutting devices when neither the first nor the second cutting devices are cutting the wrap, the first lateral offset being smaller than width W; and a second lateral offset comprising the distance between the first and second cutting devices when the first and second arms are articulated in a position where the first and second cutting devices are cutting the wrap. In some aspects, the first lateral offset is between 30% and 90% of the length of the second lateral offset.

In another aspect, the first arm is configured to allow movement of the first cutting device at least between the first lateral offset and the second lateral offset; and the second arm is configured to allow movement of the second cutting device at least between the first lateral offset and the second lateral offset.

In some aspects, the plurality of conveyors are configured so that at least one of the plurality of conveyors peels away the drop section by engaging the plurality of cleats against the drop section, thereby peeling the drop section away from the bale and pulling the drop section below the bed. In another aspect, the plurality of conveyors comprises at least two conveyors spaced apart by no more than 90% of the length of the second lateral offset.

In another aspect, the cutting height is between 15 and 90 cm above a plane where the bale contacts the bed and the drop section comprises between about 10% to 45% of the surface area of the wrap.

The bale cutting system can further comprise a hitch coupled to the bed; and at least two wheels coupled to the bed, the hitch and the at least two wheels adapted to be towed by coupling the bed to a vehicle.

In an aspect, a method for cutting a wrap from a bale can comprise moving a bale in a first direction from an entrance portion of a bed towards an exit portion of the bed, the bale being enclosed at least partially by a wrap; cutting the wrap on a first side of the bale and cutting the wrap on a second side of the bale, thereby cutting a drop section of the wrap; and peeling the drop section away from the bale by engaging a plurality of cleats against the drop section in a second direction approximately opposite the first direction.

The method for cutting a wrap from a bale can further comprise passively articulating a first cutting device, which is configured to cut the wrap on the first side of the bale, and a second cutting device, which is configured to cut the wrap on the second side of the bale, towards the exit portion of the bed by up to 75° with respect to a resting position of the first and second cutting devices, the passive articulation resulting from at least the bale moving between the first and second cutting devices; and returning the first and second cutting devices to the resting position.

In some aspects, the first and second cutting devices return to the resting position after the bale has moved past the first and second cutting devices and the drop section has been cut. In another aspect, the first and second cutting devices return to the resting position after at least six bales have moved past the first and second cutting devices, each of the at least six bales being positioned end to end and separated from an adjacent bale by no more than 60 cm.

The method for cutting a wrap from a bale can further comprise depositing the drop section below the bed by disengaging the plurality of cleats from the drop section.

In an aspect, a bale cutting system can comprise a bed having a plurality of rollers configured to roll a bale in a first direction from an entrance portion of the bed towards an exit portion of the bed, the bale having a length L and a width W; a first cutting device movably coupled to a first side portion of the bed; a second cutting device movably coupled to a second side portion of the bed, the second cutting device being positioned approximately opposite the first cutting device at a distance of between about 50% to 90% of the width W, wherein the first and second cutting devices are configured to cut a drop section of a wrap enclosing at least some of the bale, the drop section comprising between about 10% to 60% of the surface area of the wrap; and a husking device having a plurality of cleats configured to peel the drop section away from the bale and pull the drop section below the plurality of rollers, the husking device being positioned between the first and second cutting devices and the exit portion.

In some aspects, at least one of the first and second cutting devices are configured to cut the wrap at a cutting height of between 15 and 60 cm above a plane where the bale contacts the bed.

In another aspect, the first and second cutting devices are configured to passively articulate towards the exit portion of the bed by up to 75° with respect to a resting position of the first and second cutting devices, the passive articulation resulting from at least the bale moving between the first and second cutting devices; and returning the first and second cutting devices to the resting position only after at least six bales have moved past the first and second cutting devices, each of the at least six bales being positioned end to end and separated from an adjacent bale by no more than 60 cm.

The bale cutting system can further comprise a husking roller coupled to the bed in parallel with at least one of the plurality of rollers and configured to rotate in a second direction approximately opposite the first direction; a bar below the husking roller; and a plurality of conveyors coupled to and configured to rotate around the husking roller and the bar, wherein the plurality of cleats are coupled to the plurality of conveyors and are configured to protrude from the husking roller by 1 to 12 cm.

Aspects and applications of the disclosure are described below with reference to the DRAWINGS and the DETAILED DESCRIPTION. Unless specifically noted, the words and phrases in the specification and the claims should be given their plain, ordinary, and accustomed meaning to those of ordinary skill in the applicable arts. The inventor is fully aware that he can be his own lexicographer if desired. The inventor expressly elects, as his own lexicographer, to use only the plain and ordinary meaning of terms in the specification and claims unless they clearly state otherwise and then further, expressly set forth the “special” definition of that term and explain how it differs from the plain and ordinary meaning Absent such clear statements of intent to apply a “special” definition, it is the inventor's intent and desire that the simple, plain and ordinary meaning to the terms be applied to the interpretation of the specification and claims.

The inventor is also aware of the normal precepts of English grammar. Thus, if a noun, term, or phrase is intended to be further characterized, specified, or narrowed in some way, then such noun, term, or phrase will expressly comprise additional adjectives, descriptive terms, or other modifiers in accordance with the normal precepts of English grammar. Absent the use of such adjectives, descriptive terms, or modifiers, it is the intent that such nouns, terms, or phrases be given their plain, and ordinary English meaning to those skilled in the applicable arts as set forth above.

### BRIEF DESCRIPTION OF THE DRAWINGS

FIG. 1 shows a non-limiting example of a side view of a bale cutting system.

FIG. 2 shows a non-limiting example of a perspective view of a bale cutting system.

FIG. 3 shows a non-limiting example of a front view of a bale cutting system.

FIGS. 4A and 4B show non-limiting examples of detailed front and rear perspective views of a cutting device configured for use in a bale cutting system.

FIGS. 5A and 5B show non-limiting examples of a simplified plan view of a bale cutting system to depict the motion and operation of the cutting devices.

FIG. 6 shows a non-limiting example of a partial side perspective view of a bale cutting system highlighting a roller gear assembly.

FIG. 7 shows a non-limiting example of a cut-away partial side view of a bale cutting system highlighting a husking device.

FIGS. 8A and 8B show non-limiting examples of a perspective and a cross-sectional view of discrete elements of a husking device configured for use in a bale cutting system.

### DETAILED DESCRIPTION

This disclosure, its aspects and implementations, are not limited to the specific material types, components, methods, or other examples disclosed herein. Many additional material types, components, methods, and procedures known in the art are contemplated for use with particular implementations from this disclosure. Accordingly, for example, although particular implementations are disclosed, such implementations and implementing components may comprise any components, models, types, materials, versions, quantities, and/or the like as is known in the art for such systems and implementing components, consistent with the intended operation.

The words “exemplary,” “example,” or various forms thereof are used herein to mean serving as an example, instance, or illustration. Any aspect or design described herein as “exemplary” or as an “example” is not necessarily to be construed as preferred or advantageous over other aspects or designs. Furthermore, examples are provided solely for purposes of clarity and understanding and are not meant to limit or restrict the disclosed subject matter or relevant portions of this disclosure in any manner. It is to be appreciated that a myriad of additional or alternate examples of varying scope could have been presented, but have been omitted for purposes of brevity.

While this disclosure includes embodiments of many different forms, there is shown in the drawings and will herein be described in detail particular embodiments with the understanding that the present disclosure is to be considered as an exemplification of the principles of the disclosed methods and systems, and is not intended to limit the broad aspect of the disclosed concepts to the embodiments illustrated.

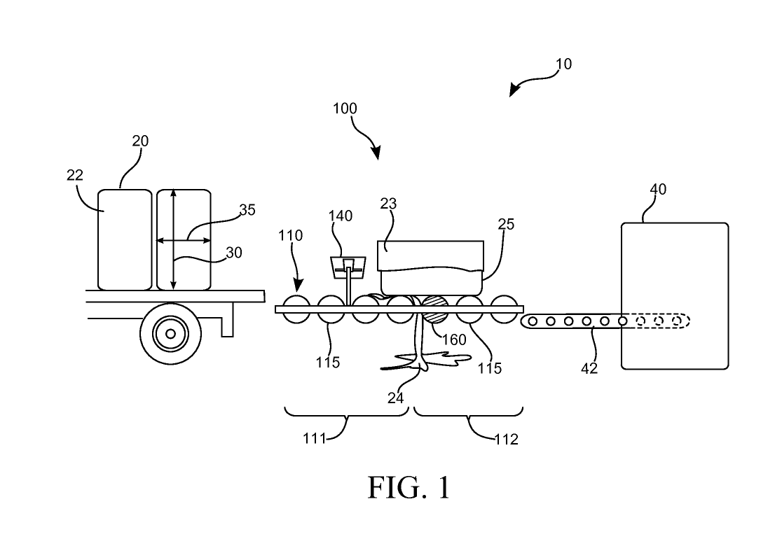

FIG. 1 shows a non-limiting example of a side view of a bale cutting system 100. Bale cutting system 100 may be used in a an offloading and bale feeding process 10 where bales 20 of products covered with a wrap 22 are offloaded from truck 15 and moved into a processing machine or processor 40. Bale cutting system 100 may comprise a bed 110 configured to move bale 20 from the entrance 111 of bed 110 to the exit 112 of bed 110 using a belt, a tilted smooth surface, rollers 115, or similar surfaces and/or mechanisms configured to move large and heavy objects. As bale 20 passes by cutting device 140, the wrap 22 enclosing bale contents 25 is cut into two pieces: a top wrap section 23 and a drop section 24. As bale 20 continues to move towards the exit 112 of bed 110, a husking device 160 peels away the drop section 24 and deposits the drop section 24 below bed 110. A user then manually removes the top wrap section 23 (e.g., hooking or grabbing the top wrap section 23 by hand or with a hook, pole, or other suitable device while the bale 20 is on bed 110 or after bale 20 has moved onto processor table 42). Bale 20 then proceeds onto processor table 42 and into processor 40. Processor table 42 may comprise any sort of conveying means, such as rollers, conveyor belts, slides, walking floors (e.g., manufactured by Keith Mfg. Co.), or other conveying means suitable for transporting bale 20. The bale contents 25 undergo processing in the processor 40 (e.g., removing debris or contaminants from bale contents 25) and then proceed to additional processing machine(s) 50 via processing transport(s) 52.

Bale 20 may comprise any one of a number of types of bales or modules used in gathering or binding agricultural (including forestry), animal, waste, recycling, natural or synthetic fibers, or other products packaged in bales. For the purposes of this disclosure, a bale 20 comprises a wrap 25 that the disclosed cutting device(s) 140 are capable of cutting, such as wrap 25 materials like: plastic sheets, nets, or twine; natural fibers or twine; synthetic or natural fabrics or cloths; relatively thin gauges of metal wire; and other similar materials configured to wrap bales 20. For example, bale contents 25 housed within wrap 22 of bale 20 may be hay, alfalfa, straw, or grass in certain embodiments. Other embodiments may comprise cotton as bale contents 25. Further embodiments may process bales 20 comprising recyclable goods, such as plastic or paper, as bale contents 25. Certain embodiments may process bales 20 comprising wool, other animal products, or natural or synthetic fibers as bale contents 25. Still further embodiments may process bales 20 comprising yard waste, such as leaves housed within a bag, as bale contents 25. For ease of discussion in this disclosure, bales 20 are generally described in terms of length 30 and diameter 35, indicating a cylindrically shaped bale. However, bales 20 may generally comprise a rectangular shape (e.g., some hay or straw bales), a spherical shape, an irregular shape (e.g., yard waste in a trash bag), or other shape generally used to hold together loose products in a bale. The dimensions of different shaped bales 20 can be measured, for example: in length 30 and diameter 35 for cylindrical bales 20; length, width, and height for rectangular bales 20, or other dimensions for other shapes. In sum, a bale 20 comprises a multitude of possible shapes and sizes in addition to the numerous wrap 22 materials and types discussed herein along with wrapping means yet to be developed may be used in lieu of—or in conjunction with—any of the wraps, ties, nets, bags, or wrapping means discussed above.

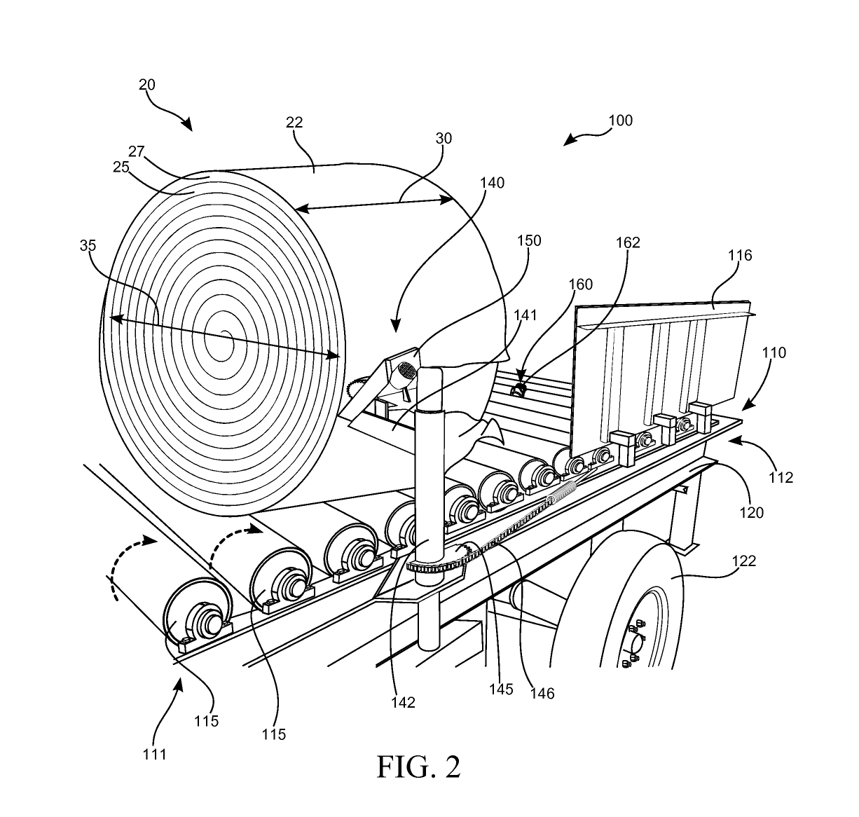

In some embodiments the offloading and bale feeding process 10 is used with bales 20 having cotton as bale contents 25. For example, harvested cotton is wrapped into bales 20 by a cotton harvester such as a John Deere® 7760 Cotton Picker, which wraps harvested cotton into cylindrically shaped bales 20 using a plastic material for wrap 22. The bale 20 of cotton is typically about 80-120 inches in length 30 and 50-100 inches in diameter 35 (e.g., a target length 30 by diameter 35 of about 106 by 66 inches, 106 by 78 inches, or 106 by 90 inches to within a tolerance of ±6 inches). Stated in metric, the bale 20 of cotton is typically about 200-300 cm in length 30 and 130-250 cm in diameter 35 (e.g., a target length 30 by diameter 35 of about 270 by 170 cm, 270 by 200 cm, or 270 by 230 cm to within a tolerance of ±15 cm). The plastic of this wrap 22 encases the curved cylindrical sides of bale 20, but leaves at least a portion of the flat ends of the cylinder exposed and unwrapped (see FIG. 2). In the processing of cotton, the wrapped cylinder of harvested cotton produced by a cotton harvester is customarily called a “module” rather than a “bale” because a “cotton bale” generally referred to a rectangular bale of cotton that had been processed in a cotton gin, compressed, and wrapped with wires (e.g., a 500 pound (about 225 kg) Gin Universal Density Bale that is roughly 55×20×33 inches or 140×50×84 cm). Historically, cotton modules were very large and were not tightly bound or wrapped as is common with bales, but the cotton modules were often covered for protection from the elements. More recently, smaller cotton modules were introduced, such as the round cotton modules assembled and wrapped by a single machine that is simultaneously harvesting the cotton (e.g., the John Deere® 7760 Cotton Picker). However, this disclosure will refer to the cotton modules containing cotton unprocessed in a gin as “bales 20” rather than “modules” because the term “bales” is more commonly used among the various agricultural, waste, and other industries to conveniently bundle loose products into bales 20. Thus, references herein to “bales 20” may comprise what is commonly referred to as cotton modules of any shape, whether they be round, rectangular, cylindrical, or other shapes of cotton modules. Moreover, the term “bale 20” may also refer to traditional cotton bales (e.g., 500 lbs. rectangular bales) containing ginned cotton, depending on whether the wrapping material is a material capable of being cut by cutting device 140.

In embodiments where bales 20 have cotton as bale contents 25 the processor 40 may comprise one or more machines utilized in ginning and processing cotton, such as a module feeder, gin feeder, dryer, cylinder cleaner, stick machine, gin stand, lint cleaner, and/or bale press. In some embodiments processor 40 comprises at least a module feeder such as a Stover Moving Floor Module Feeder made by Stover Equipment Co. or a Cotton Module Feeder made by Cherokee Fabrication Co.

In embodiments where bales 20 have hay, straw, or similar contents as bale contents 25 the processor 40 may comprise one or more machines utilized in processing hay, straw, and so on. In embodiments where bales 20 have recyclable goods as bale contents 25 the processor 40 may comprise one or more machines utilized in processing recyclable goods.

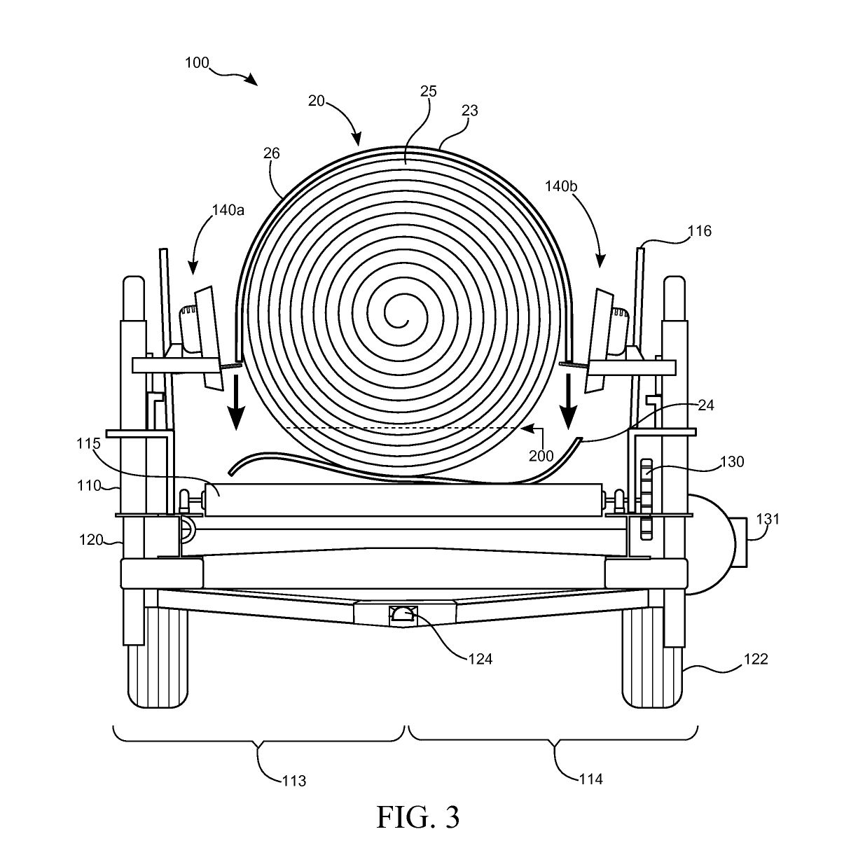

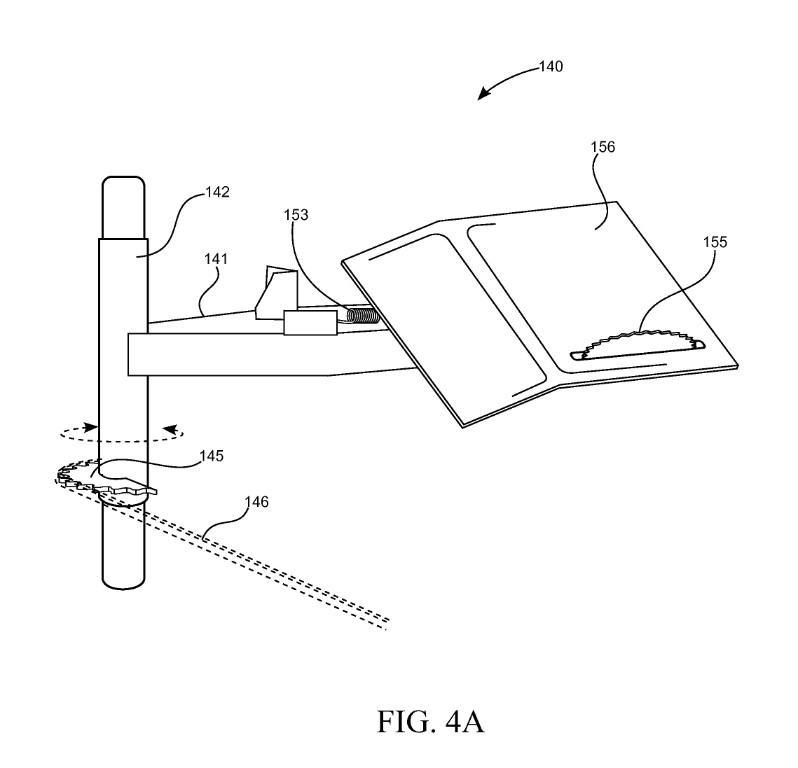

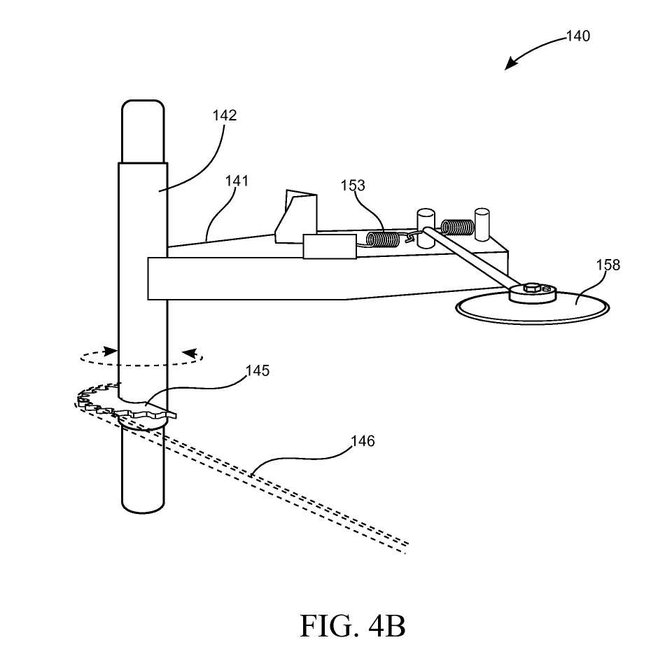

FIGS. 2 and 3 show non-limiting examples of a perspective and front view of bale cutting system 100. FIGS. 4A and 4B show non-limiting examples of detailed front and rear perspective views of cutting device 140. Bale cutting system 100 may comprise a bed 110 coupled to trailer 120 comprising at least two trailer wheels 122 and a hitch 124 to allow bale cutting system 100 to be easily transported. Bale cutting system 100 may further comprise cutting devices 140, swing arms 141, rotators 142, rotator tensioners 144, sprockets 145, spring-loaded chains 146, side guards 116, rollers 115, roller gear assembly 130, motor 131, husking device 160, cleats 162, husking conveyor 163, cutting head assembly 150, tensioner 153, blade 155, and head shield 156.

Bales 20 enter bed 110 at the entrance portion 111 and are moved past two cutting devices 140, which cut the wrap 22 encasing at least a portion of the sidewalls 26 of bale 20 into two sections: a lower drop section 24 and a top wrap section 23. The bale 20 proceeds moving along bed 110 as it passes over husking device 160, which employs a plurality of cleats 162 coupled to a counter-circulating conveyor, chain, or belt 163 that is configured to engage and snag at least some of the cleats 162 into the drop section 24 of wrap 22, resulting in the drop section 24 being peeled away from the lower portion of bale 20 (see FIG. 3). Bale 20 continues to move past husking device 160 and exits bed 110 at exit portion 112 to be deposited on processor table 42. Side guards 116 may be coupled to bed 110 or trailer 120 in some embodiments to help prevent the bale contents 25 from spilling out the left or right side of bale cutting system 100 as bale 20 passes exit portion 112 with at least the drop section 24 removed from bale 20.

Bale cutting system 100 may comprise two or more cutting devices 140, such as a left cutting device 140a coupled to a left-side portion 113 of bed 110 and a right cutting device 140b coupled to a right-side portion 114 of bed 110. Cutting devices 140a and 140b are positioned approximately opposite each other on bed 110 and generally mirror each other in movement, placement, and function. Cutting head assembly 150 comprises a blade 155 and is coupled to swing arm 141 in a fixed or moveable manner, such as with head tensioner 153. Swing arm 141 is coupled to rotator 142 and configured to swing in generally lateral movements from the middle of bed 110 towards a side of bed 110 with the aid of rotator tensioner 144. Cutting head assembly 150, swing arm 141, and rotator 142 are configured to move (using, e.g., rotator tensioner 144 and/or head tensioner 153) in a manner that allows blade 155 to cut wrap 22 into drop section 24 and top wrap section 23.

Rotator tensioner 144 may comprise a spring-loaded chain 146 mated with the teeth of a sprocket 145 coupled to rotator 142. The size and shape of sprocket 145 and the degree of tension of the spring-loaded chain 146 will help determine the amount movement allowed and resistance to movement that occurs as the cutting head assembly 150 swings while engaging with a passing bale 20. In a similar fashion, head tensioner 153 may allow for movement of the cutting head assembly 150 with respect to the swing arm 141 by way of a spring loaded chain 154 engaged with the teeth of a sprocket (not shown) coupled to the cutting head assembly 150. Cutting device 140 may comprise one or both of rotator tensioner 144 and head tensioner 153, and may comprise additional tensioners and other devices to allow for varied degrees of movement for cutting head assembly 150. Upon reading the teachings of this specification, those with ordinary skill in the art will now appreciate that, under appropriate circumstances, considering issues such as changes in technology, user requirements, etc., other tensioning means, such as cables, pulleys, counterweights, drives, telescoping arms, sliders, springs, cams, hinges, fixed tensioners, adjustable tensioners, floating mount tensioners, pneumatic tensioners, rotary tensioners, linear tensioners, and other tensioning means yet to be developed, etc., may suffice.

Cutting head assembly 150 comprises a blade 155 and can be any one of many different cutting mechanisms. For example, cutting head assembly 150 may comprise a circular saw 152 (as shown in FIGS. 2, 3, and 4A) or a fixed blade 158 which may or may not have different axes of movement and/or tensioners (as shown in FIG. 4B). Circular saw 152 may comprise a circular saw using a blade 155 with a diameter between about 4 and 10 inches (10-25 cm), such as a common 7.25 inch (18.4 cm) diameter circular saw blade powered by an electrical motor (but blade 155 of circular saw 152 may also be 0.5-20 inches or 1-50 cm in diameter, or larger). In some embodiments blade 155 used in circular saw 152 has a diameter of about 3.375 (3⅜) inches, 5 inches, 7.25 inches, 8 inches, 10 inches, or 12 inches within about ±1.5 inches (or, 8.5, 12.7, 18.4, 20.3, 25.4, or 30.5 cm to within about ±4 cm). Fixed blade 158 may comprise any one of a litany of types of straight, curved, circular (as shown in FIG. 4B) or other blades (e.g., a metal or ceramic blade) and can be 0.5-50 inches or 1-130 cm in length, or longer. Cutting head assembly may also comprise a protective head shield 156, for example, to protect machinery or moving parts behind blade 155. Upon reading the teachings of this specification, those with ordinary skill in the art will now appreciate that, under appropriate circumstances, considering issues such as changes in technology, user requirements, etc., other cutting means, such as saws, knives, axes, razors, blades, serrated blades, shears, spades, scissors, clippers, pincers, wedges, thermal lances, lasers, cutters, millers, teeth, flutes, shanks, sickles, bits, reamers, perforators, scorers, metal slitting knives, wire cutters, slab mills, side-and-face cutters, hobbing machines, and other cutting means yet to be developed, etc., may suffice. These cutting means may comprise metal, ceramic, or other materials for the blade 155 of the cutting head assembly 150, which may also have abrasive coatings, embedded abrasives, or hardening coatings.

Blade 155 of cutting head assembly 150 is designed to cut wrap 22 which encloses at least a portion of bale 20. Thus, the material used for wrap 22 relates to the choice of material, type, and style of blade 155 and the type of cutting head assembly 150. For example, a bale 20 enclosed by a wrap 22 made from plastic sheeting or mesh may be readily cut with many of the different cutting means disclosed herein, including a circular saw 152, as shown. In contrast, a bale 20 enclosed by a wrap 22 made from metal wire or straps had fewer available cutting means, but may still be cut by, for example, a cutting head assembly 150 comprising wire cutters, metal slitting knives, or similar cutting means.

Cutting devices 140 may be configured to cut wrap 22 at varying heights along sidewalls 26 of bale 20. For example, FIGS. 2 and 3 depict cutting devices 140 cutting wrap 22 approximately just below the middle of bale 20, which results in having blades 155 separated from each other by a distance nearly as long as the bale diameter 35 as blades 155 cut wrap 22 along sidewalls 26. Cutting along the exact middle of bale 20 would result in the top wrap section 23 and drop section 24 having approximately the same size. Cutting below the middle of bale 20 (as shown in FIG. 3) results in the top wrap section 23 having a larger surface area than the surface area of the drop section 24.

An imaginary polar coordinate system can be overlaid on the facing end surface 27 of bale 20, meaning that cutting along a midline is cutting at approximately 0° and 180° of a polar coordinate. Drop section 24 is shown in FIG. 3 falling or being peeled away from bale 20 after being cut. All or part of drop section 24 may separate from bale 20 simply by being cut by cutting devices 140, or may require husking device 160 to peel away all or some of drop section 24 from bale 20.

In some embodiments, cutting devices 140 may be placed lower or higher along the sidewalls 26 of bale 20. For example, lowering cutting devices 140 below the midline of bale 20 (i.e., between about 180° and 360° of polar coordinate) would place blades 155 closer together as they cut sidewalls 26 and would result in top wrap section 23 being larger than drop section 24 (depending, of course, on whether bale 20 remains cylindrical or squashes and flattens somewhat under its own weight). Alternatively, raising cutting devices 140 above the midline of bale 20 (i.e., between about 0° and 180° of polar coordinate) would also place blades 155 closer together as they cut sidewalls 26, but would result in top wrap section 23 being smaller than drop section 24. According to some embodiments, cutting device 140a is configured to cut wrap 22 (using polar coordinates) between about 160° and 250° for left-side portion 113 and cutting device 140b is configured to cut wrap 22 between about 290° and 20° for right-ride portion 114. In some embodiments cutting devices 140 approximately mirror each other's height and cutting devices 140a and 140b, respectively, cut wrap 22 at about (to within ±10°): 180°, 0°; 195°, 345° (as approximated in FIG. 3); 200°, 340°; 210°, 330°; 220°, 320°; 230°, 310°; and so forth. The polar coordinate description of cutting locations can be used to describe cutting locations on wrap 22 of bales 20 for bales 20 that are not just cylindrical, but also rectangular, square, oblong, irregular or other shapes.

An alternative way to describe the location where cutting devices 140a and 140b cut wrap 22 of bale 20 is to compare the relative amount of top wrap section 23 to the drop section 24 with respect to the original wrap 22. This description may refer to the length of the circumference of wrap 22 at a cross-section of bale 20, a total area of wrap 22, or an area of wrap 22 accounting for the sidewalls 26 and ignoring the area of wrap 22 on end surfaces 27. Thus, in some embodiments cutting devices 140 are configured to cut wrap 22 so that drop section 24 is smaller than or approximately equal to top wrap section 23. For example, the ratio (in percentages) of top wrap section 23 to drop section 24 may be about: 50%-50%; 60%-40%; 70%-30%; 75%-25%; 80%-20%; 90%-10%; and so on. Conversely, drop section 24 may also be larger than top wrap section 23 in some embodiments.

In certain embodiments, cutting devices 140 have an adjustable height so they are configured to have blades 155 engage and cut wrap 22 at various different heights selected by a user. Some embodiments configure cutting devices 140 to cut wrap 22 at a point somewhere between 5 and 150 cm above the surface of bed 110 (e.g., about 15, 20, 25, 30, 35, 45, 55, 75, etc., cm above bed 110). In some embodiments, one or more swing arms 141 are adjustable to bring cutting head assemblies 150 closer together or farther apart, thereby accommodating a wide range of diameters 35 of different bales 20. In some embodiments, cutting devices 140 are configured to cut wrap 22 for a wide range of diameters 35 of different bales 20 even though swing arms 141 have a fixed length.

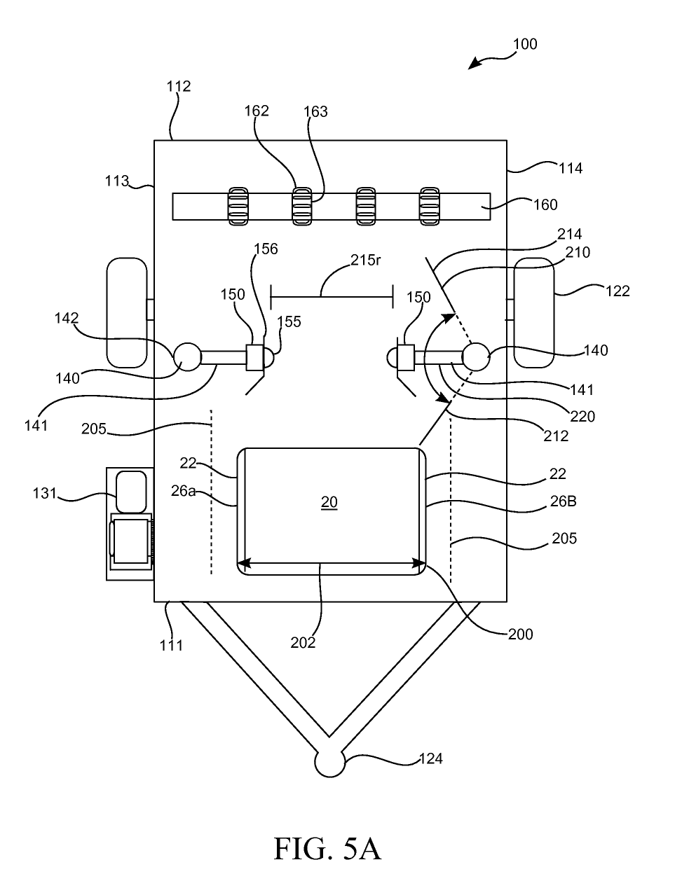

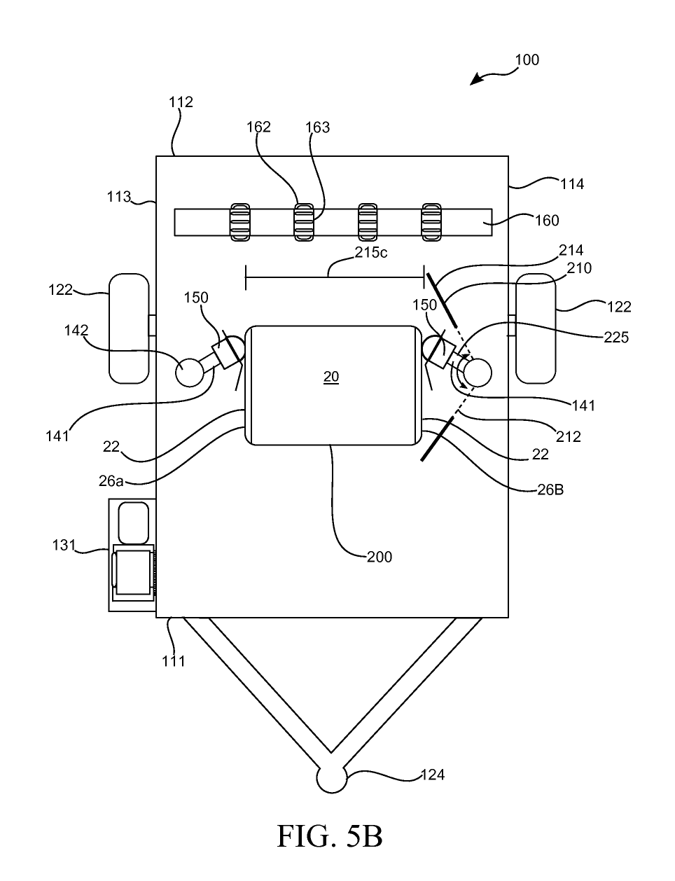

FIGS. 5A and 5B show non-limiting examples of a simplified plan view of bale cutting system 100 to depict the motion and operation of the cutting devices 140 (e.g., the views are simplified by not drawing rollers 115). Cutting devices 140a and 140b are configured to cut wrap 22 into two sections: a drop section 24 and a top wrap section 23. Bale 20 is depicted as a cross-section of bale 20 at cross-section 200 shown in FIG. 3. Lines 205 illustrate the maximum width of bale 20, which is bale diameter 35, located above cross-section 200. Cross-section 200 has a width shown as cross-section width 202, which is smaller than bale diameter 35 in the example depicted in FIGS. 5A and 5B. Cutting devices 140a and 140b may be configured to swing within an allowed swing range 210 where swing arms 141 may swing between a maximum forward swing 212 and a maximum backward swing 214. Cutting devices 140 may be configured to passively actuate between positions within maximum forward swing 212 and maximum backward swing 214 as a result of the pressure of the passing bale 20, which is counteracted by the rotator tensioner 144 and/or the head tensioner 153. Alternatively, cutting devices 140 may be configured to actively actuate between positions within maximum forward swing 212 and maximum backward swing 214 through assistance by hydraulically or electrically actuated means of moving cutting devices 140 (e.g., motors, pumps, etc.).

Cutting head assemblies 150 may be configured to be approximately opposite each other and separated by a lateral offset 215, which is denoted as a resting lateral offset 215r. Cutting devices 140 may be configured to that swing arms 141 and cutting head assemblies 150 are positioned in a resting position 220, which may be an initial position and/or a default position swing arms 141 return to after cutting a bale 20. As bale 20 proceeds from entrance portion 111, the cutting devices 140 comprise a resting lateral offset 215r that is smaller than the cross-section width 202. As bale 20 proceeds further, it begins to push against cutting devices 140a and 140b, thereby pushing cutting head assemblies 150 backwards (towards exit portion 112) and increasing the lateral offset 215 until it reaches a cutting lateral offset 215c, as shown. Cutting lateral offset 215c is the offset between cutting head assemblies 150 when they are in position to cut sidewalls 26a and 26b of wrap 22. At cutting lateral offset 215c the cutting devices 140 are in the sidewall cutting position 225. Cutting devices 140 remain in the sidewall cutting position 225 until bale 20 passes blades 155 (i.e., wrap 22 is now cut into a top wrap section 23 and drop section 24) and then the cutting devices 140 swing back into their resting position 220.

Bale cutting system 100 may be configured to accommodate a very wide variety of dimensions of bales 20, wrap 22 types, and/or accommodate bales 20 that are not centered on bed 110. For example, if the resting lateral offset 215r is equal to the cross-section width 202, then a bale 20 that is too far to the left or right on bed 110 will not contact one of the blades 155. Thus, the cutting devices 140 may be configured with a resting lateral offset 215r sufficiently small to accommodate bale 20 placement deviations to the left or right of the centerline of bed 110. For example, resting lateral offset 215r may be set to about 90%, 80%, 60%, 50%, 25%, etc., of cross-section width 202. Some embodiments may have a resting lateral offset 215r of zero or nearly zero and may add a vertical offset to allow blades 155 to overlap each other.

Moreover, bale cutting system 100 may cut the wrap 22 from bales 20 in an uninterrupted manner by placing numerous bales 20 end to end. In fact, bales 20 may be placed adjacent or close together (e.g., up to 15, 30, 60, 75, or 100 cm apart) so that cutting head assemblies 150 do not return to the resting position 220 (corresponding to the resting lateral offset 215r) until after the closely positioned bales 20 have been cut. In some embodiments, bale cutting system 100 is configured to cut the drop section 24 from the wrap 22 of at least 2 (e.g., 4, 6, 9, 12, 20, etc.) bales 20 positioned closely together (e.g., up to 15, 30, 60, 75, or 100 cm apart). The capability of bale cutting system 100 to sequentially cut several, or even several dozen or more, bales 20 without interruption is a marked improvement over existing technologies that require interruptions resulting in processing of bales 20 individually or in batches of up to four bales 20.

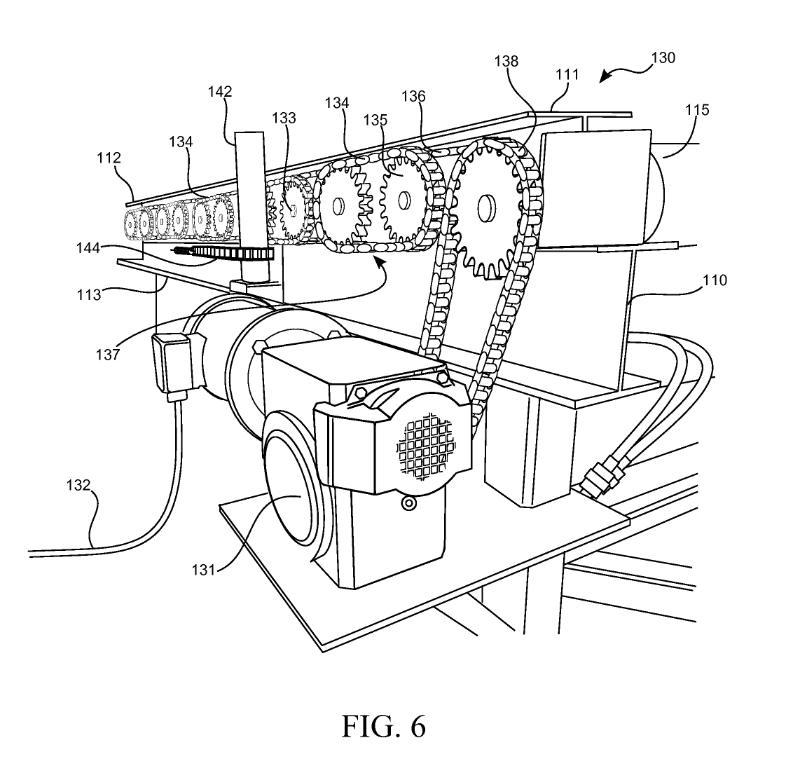

FIG. 6 shows a non-limiting example of a partial side perspective view of bale cutting system 100 highlighting the roller gear assembly 130. Roller gear assembly 130 is configured to drive the plurality of rollers 115 so that a bale placed on top of rollers 115 will move from the entrance portion 111 to the exit portion 112 of bed 110. Roller gear assembly 130 may comprise a motor 131 powered by a power source 132 (e.g., 120 or 240 volts A/C current) and coupled to a drive chain 138 that is coupled to a plurality of outer sprockets 135 and inner sprockets 137 (not shown) that rotate around pins 133 when engaged by outer chains 134 and inner chains 136. At least one of each of the outer sprockets 135 and/or inner sprockets 137 is coupled and engages with a roller 115, causing roller 115 to rotate when the corresponding and coupled sprocket 135/137 rotates. Inner sprocket 137 is coaxially aligned around pin 133 with outer sprocket 135, but obscured from view in FIG. 6. When motor 131 causes drive chain 138 to rotate, the outer chains 134 and inner chains 136 cause outer sprockets 135 and inner sprockets 137 to rotate, thereby engaging each coupled roller 115 and creating a moving surface on bed 110 that can transport bale 20. Upon reading this specification, those skilled in the art will now appreciate that, under appropriate circumstances, considering such issues as future technology, cost, application requirements, etc., other transporting means, such as, for example, belts, conveyors, chain drive beds, ramps, tables, wheels, etc., may suffice to transport bales 20 from the entrance portion 111 to the exit portion 112 of bed 110.

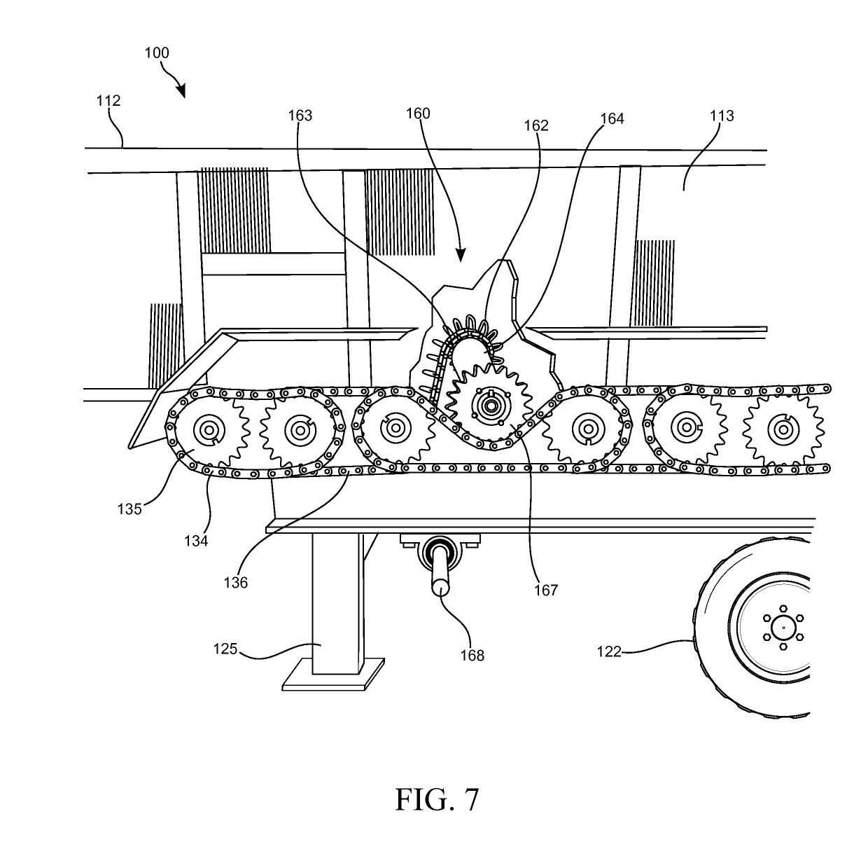

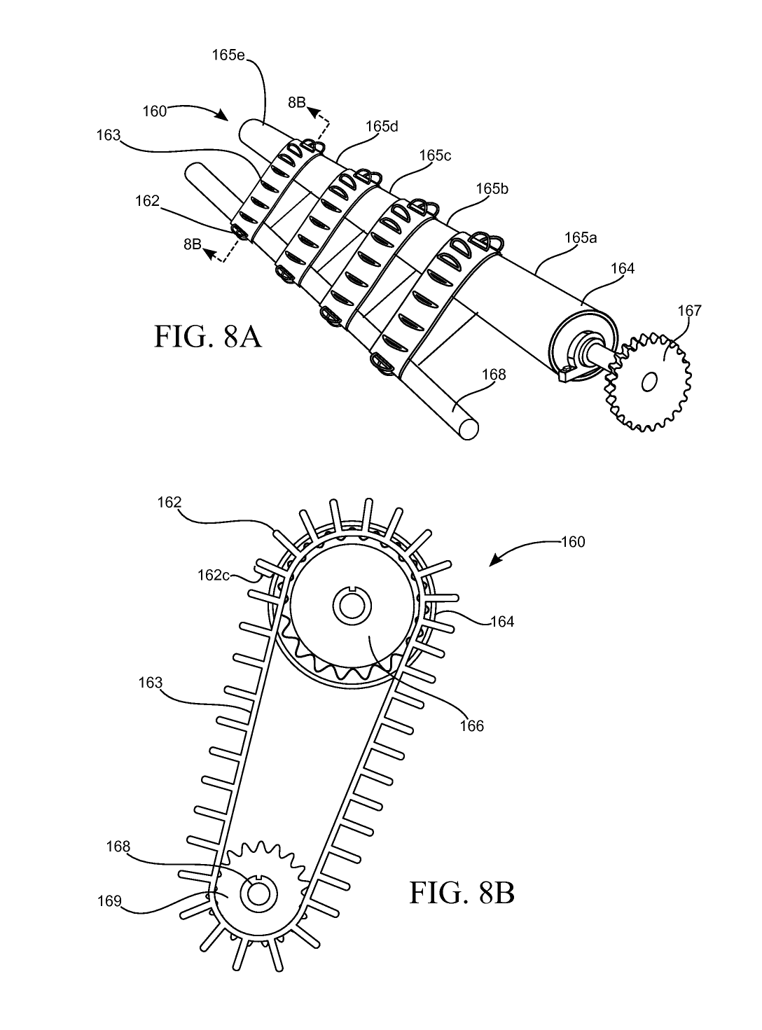

FIG. 7 shows a non-limiting example of a simplified partial side perspective view of bale cutting system 100 highlighting the husking device 160. FIGS. 8A and 8B show non-limiting examples of a perspective and a cross-sectional view of discrete elements of the husking device 160. Husking device 160 may comprise: a plurality of cleats 162 coupled to a husking conveyor 163, a husking conveyor sprocket 166, a husking roller 164, a husking sprocket 167, a lower rod 168, and a lower rod sprocket 169. FIG. 7 also depicts an example of an embodiment comprising at least one support 125 to trailer 120 (e.g., a mechanical or hydraulic stability support).

Husking device 160 may be configured to peel drop section 24 of wrap 22 away from bale 20, thereby leaving the bale contents 25 exposed and unwrapped in at least the section of bale 20 covered by the drop section 24. Husking device 160 may comprise a plurality of husking conveyors 163, such as 2, 3 (as shown in FIG. 8A), 4, 5, etc., positioned along husking roller 164. At least the plurality of cleats 162 coupled to the husking conveyor(s) 163 rotate in a counter-rotating direction, which is the opposite direction than rollers 115 are rotating. As motor 131 drives sprockets 135/137 and chains 134/136, at least one chain 134/136 is configured to engage husking sprocket 167 so that husking sprocket 167 causes at least the husking conveyors 163 to counter-rotate by being engaged by the husking conveyor sprockets 166. At least some of the he counter-rotating cleats 162 engage or snag a portion of the drop section 24 and begin to pull or peel the drop section 24 away from bale 20. The husking conveyors 163 also couple to a lower rod 168 via lower rod sprockets 169. Lower rod 168 may be below and offset towards the exit portion 112 with respect to the husking roller 164, which may improve performance by providing a space under husking conveyors 163 for drop section 24 to release and drop from the cleats 162 before husking conveyors 163 turn at the lower rod sprockets 169 and begin climbing back up towards the husking roller 164.

Cleats 162 are configured to snag or grab the drop section 24 with sufficient strength to peel the drop section 24 away from bale 20, but also have the ability to release drop section 24 below bed 110 before husking conveyors 163 climb back upwards to the husking roller 164. Cleats 162 may comprise a variety of shapes and configurations, such as: rounded, square, triangular, angled, flexible, hinged, and so forth. Depending on the intended application, cleats 162 may protrude from husking conveyors 163 approximately 0.2 to 8 inches (depicted as protruding distance 162c in FIG. 8B) and may be spaced approximately 0.5 to 12 inches or 1-30 cm apart. In some embodiments, cleats 162 are spaced about 1-4 inches or 2-10 cm apart, protrude by about 0.5-3 inches or 1-8 cm, and are shaped rounded and smooth to allow snagging the drop section 24 without piercing the drop section 24 material.

According to some embodiments, bed 110 is approximately: 2.5 to 4 m wide (between sides 113/114), 3 to 5 m long (between ends 111/112), and configured for bales 20 to roll at a bed 110 height of 50 to 120 cm. In some embodiments, bed 110 is approximately (to within 20 cm): 3.3 m wide, 3.5 m long, and configured for bales 20 to roll at a bed 110 height of 85 cm. In some embodiments, rollers 115 are approximately: 16 cm or 3 to 40 cm in diameter (e.g., 8, 12, 18, 25, etc., cm) and 270 cm or 200 to 400 cm in length (e.g., 225, 250, 290, 320, etc., cm). Swing arm 141 may have a length of about 80 cm or 10-150 cm in some embodiments. In some embodiments, motor 131 is configured to advance bales 20 placed on bed 110 at a rate of about 40 cm per second or between about 5 to 70 cm per second. In some embodiments, bed 110 comprises at least 8, 12, 16, 20, etc., rollers 115. In some embodiments, husking roller 164 has a diameter that is about 10% or between 5% and 50% larger than the diameter of rollers 115. In some embodiments, the axis of husking roller 164 couples to bed 110 by about 3-6 cm or 2-10 cm higher than the plane where the axes of rollers 115 couple to bed 110.

Where the above examples, embodiments and implementations reference examples, it should be understood by those of ordinary skill in the art that other bale cutting systems and manufacturing devices and examples could be intermixed or substituted with those provided. In places where the description above refers to particular embodiments of bale cutting systems and customization methods, it should be readily apparent that a number of modifications may be made without departing from the spirit thereof and that these embodiments and implementations may be applied to other to bale cutting system customization technologies as well. Accordingly, the disclosed subject matter is intended to embrace all such alterations, modifications and variations that fall within the spirit and scope of the disclosure and the knowledge of one of ordinary skill in the art.

Any dimensions presented in this document are for example only and not a limitation on the scope of this disclosure. It will be understood that embodiments are not limited to the specific components disclosed herein, as virtually any components consistent with the intended operation of the method or system may be utilized. Accordingly, for example, although particular materials, structures, and couplings may be disclosed, such components may comprise any shape, size, style, type, model, version, class, grade, measurement, concentration, material, weight, quantity, or the like consistent with the intended operation of a bale cutting system 20.

Accordingly, the components defining any bale cutting system embodiment may be formed of any of many different types of materials or combinations thereof that can readily be formed into shaped objects provided that the components selected are consistent with the intended operation of a bale cutting system embodiment. For example, the components can comprise one or more: polymers such as thermoplastics (such as ABS, Fluoropolymers, Polyacetal, Polyamide; Polycarbonate, Polyethylene, Polysulfone, or other similar material), thermosets (such as Epoxy, Phenolic Resin, Polyimide, Polyurethane, Silicone, or other similar material); glasses (such as quartz glass), carbon-fiber, aramid-fiber, any combination thereof, or other similar material; composites; metals, such as zinc, magnesium, titanium, copper, lead, iron, steel, carbon steel, alloy steel, tool steel, stainless steel, brass, tin, antimony, pure aluminum, 1100 aluminum, aluminum alloy, or other similar materials; alloys, such as aluminum alloy, titanium alloy, magnesium alloy, copper alloy, any combination thereof, or other similar materials; and one or more of any of the above with one or more or other similar material.

Various bale cutting system embodiments may be manufactured using conventional procedures as added to and improved upon through the procedures described here. Some components may be manufactured simultaneously and integrally joined with one another, while other components may be purchased pre-manufactured or manufactured separately and then assembled with the integral components.

Accordingly, manufacture of these components separately or simultaneously may involve one or more of extrusion, pultrusion, vacuum forming, injection molding, blow molding, resin transfer molding, casting, forging, cold rolling, milling, drilling, reaming, turning, grinding, stamping, cutting, bending, welding, soldering, hardening, riveting, punching, plating, or other similar process. If any of the components are manufactured separately, they may then be coupled with one another in any suitable manner, such as with adhesive, a weld, a fastener (e.g., a bolt, a nut, a screw, a nail, a rivet, a pin), wiring, any combination thereof, and/or the like for example, depending on, among other considerations, the particular material forming the components.

Upon reading the teachings of this specification, those with ordinary skill in the art will appreciate that, under certain circumstances, considering issues such as changes in technology, user requirements, etc., a variety of fastening devices may be used to affix, couple, or releasably couple, (as those words are used herein) one or more components of the present disclosure. These fastening devices may comprise one or more of the following: adhesives, belts, bolts, buckles, clasps, latches, locks, screws, snaps, clamps, connectors, couplings, ties, or other fastening means yet to be developed.

Likewise, upon reading the teachings of this specification, those with ordinary skill in the art will appreciate that, under certain circumstances, considering issues such as changes in technology, subject requirements, etc., a variety of fastening devices, such as adhesives, belts, bolts, buckles, clasps, latches, locks, screws, snaps, clamps, connectors, couplings, ties or other fastening means yet to be developed may be used in lieu of—or in conjunction with—any of the fasteners or fastening means discussed above.

It will be understood that the assembly of bale cutting system embodiments are not limited to the specific order of steps as disclosed in this document. Any steps or sequence of steps of the assembly of bale cutting system embodiments indicated herein are given as examples of possible steps or sequence of steps and not as limitations, since various assembly processes and sequences of steps may be used to assemble bale cutting system embodiments.

In places where the description above refers to particular embodiments, it should be readily apparent that a number of modifications may be made without departing from the spirit thereof and that these embodiments may be applied to other embodiments disclosed or undisclosed. The accompanying claims are intended to cover such modifications as would fall within the true spirit and scope of the disclosure set forth in this document. The presently disclosed embodiments are, therefore, to be considered in all respects as illustrative and not restrictive, the scope of the disclosure being indicated by the appended claims rather than the foregoing description. All changes that come within the meaning of and range of equivalency of the claims are intended to be embraced therein.

What is claimed is:

1. A bale cutting system, comprising:
a bed configured to move a bale having a length L and a width W from an entrance portion of the bed towards an exit portion of the bed;
a first cutting device movably coupled to a first side portion of the bed through a first arm;
a second cutting device movably coupled to a second side portion of the bed through a second arm, the second cutting device being positioned approximately opposite the first cutting device; and
a plurality of cleats positioned between the first and second cutting devices and the exit portion, wherein the plurality of cleats are coupled to a plurality of conveyors configured to rotate against the movement of the bale.

2. The bale cutting system of claim 1, wherein the first and second cutting devices are configured to cut a drop section of a wrap enclosing at least some of the bale by cutting the wrap at a cutting height.

3. The bale cutting system of claim 2, further comprising:
a first lateral offset comprising the distance between the first and second cutting devices when neither the first nor the second cutting devices are cutting the wrap, the first lateral offset being smaller than width W; and
a second lateral offset comprising the distance between the first and second cutting devices when the first and second arms are articulated in a position where the first and second cutting devices are cutting the wrap.

4. The bale cutting system of claim 3, wherein the first lateral offset is between 30% and 90% of the length of the second lateral offset.

5. The bale cutting system of claim 4, wherein:
the first arm is configured to allow movement of the first cutting device at least between the first lateral offset and the second lateral offset; and
the second arm is configured to allow movement of the second cutting device at least between the first lateral offset and the second lateral offset.

6. The bale cutting system of claim 3, wherein the plurality of conveyors are configured so that at least one of the plurality of conveyors peels away the drop section by engaging the plurality of cleats against the drop section, thereby peeling the drop section away from the bale and pulling the drop section below the bed.

7. The bale cutting system of claim 6, wherein the plurality of conveyors comprises at least two conveyors spaced apart by no more than 90% of the length of the second lateral offset.

8. The bale cutting system of claim 3, wherein the cutting height is between 15 and 90 cm above a plane where the bale contacts the bed and the drop section comprises between about 10% to 45% of the surface area of the wrap.

9. The bale cutting system of claim 1, wherein at least one of the first and second cutting devices comprise a powered circulating saw.

10. The bale cutting system of claim 9, wherein the powered circulating saw comprises a circulating saw blade having a blade diameter of 10 to 25 cm.

11. The bale cutting system of claim 1, further comprising:
a hitch coupled to the bed; and
at least two wheels coupled to the bed, the hitch and the at least two wheels adapted to be towed by coupling the bed to a vehicle.

12. A method for cutting a wrap from a bale comprising:
moving a bale in a first direction from an entrance portion of a bed towards an exit portion of the bed, the bale being enclosed at least partially by a wrap;
cutting the wrap on a first side of the bale and cutting the wrap on a second side of the bale, thereby cutting a drop section of the wrap; and
peeling the drop section away from the bale by engaging a plurality of cleats against the drop section in a second direction approximately opposite the first direction.

13. The method for cutting the wrap from the bale of claim 12, further comprising:
passively articulating a first cutting device, which is configured to cut the wrap on the first side of the bale, and a second cutting device, which is configured to cut the wrap on the second side of the bale, towards the exit portion of the bed by up to 75° with respect to a resting position of the first and second cutting devices, the passive articulation resulting from at least the bale moving between the first and second cutting devices; and
returning the first and second cutting devices to the resting position.

14. The method for cutting the wrap from the bale of claim 13, wherein the first and second cutting devices return to the resting position after the bale has moved past the first and second cutting devices and the drop section has been cut.

15. The method for cutting the wrap from the bale of claim 13, wherein the first and second cutting devices return to the resting position after at least six bales have moved past the first and second cutting devices, each of the at least six bales being positioned end to end and separated from an adjacent bale by no more than 60 cm.

16. The method for cutting the wrap from the bale of claim 12, further comprising:
depositing the drop section below the bed by disengaging the plurality of cleats from the drop section.

17. A bale cutting system, comprising:
a bed having a plurality of rollers configured to roll a bale in a first direction from an entrance portion of the bed towards an exit portion of the bed, the bale having a length L and a width W;
a first cutting device movably coupled to a first side portion of the bed;
a second cutting device movably coupled to a second side portion of the bed, the second cutting device being positioned approximately opposite the first cutting device at a distance of between about 50% to 90% of the width W, wherein the first and second cutting devices are configured to cut a drop section of a wrap enclosing at least some of the bale, the drop section comprising between about 10% to 60% of the surface area of the wrap; and
a husking device having a plurality of cleats configured to peel the drop section away from the bale and pull the drop section below the plurality of rollers, the husking device being positioned between the first and second cutting devices and the exit portion.

18. The bale cutting system of claim 17, wherein at least one of the first and second cutting devices are configured to cut the wrap at a cutting height of between 15 and 60 cm above a plane where the bale contacts the bed.

19. The bale cutting system of claim 17, wherein:
the first and second cutting devices are configured to passively articulate towards the exit portion of the bed by up to 75° with respect to a resting position of the first and second cutting devices, the passive articulation resulting from at least the bale moving between the first and second cutting devices; and
returning the first and second cutting devices to the resting position only after at least six bales have moved past the first and second cutting devices, each of the at least six bales being positioned end to end and separated from an adjacent bale by no more than 60 cm.

20. The bale cutting system of claim 17, wherein the husking device further comprises:
a husking roller coupled to the bed in parallel with at least one of the plurality of rollers and configured to rotate in a second direction approximately opposite the first direction;
a bar below the husking roller; and
a plurality of conveyors coupled to and configured to rotate around the husking roller and the bar, wherein the plurality of cleats are coupled to the plurality of conveyors and are configured to protrude from the husking roller by 1 to 12 cm.
